(19) United States
(12) Patent Application Publication
(10) Pub. No.: US 2007/0103616 A1
(43) Pub. Date: May 10, 2007

(54) Liquid crystal display with frame stopper blocking liquid crystal panel

(75) Inventors: Cheng-Hsien Yu, Miao-Li (TW); Cheng-Feng Tsai, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/593,310

(22) Filed: Nov. 6, 2006

(30) Foreign Application Priority Data
Nov. 4, 2005 (TW) 94138763

(51) Int. Cl. G02F 1/1333

(52) U.S. Cl. 349/58

(57) ABSTRACT

An exemplary liquid crystal display (1) includes a liquid crystal panel (13) and a frame (12) receiving the liquid crystal panel. The frame includes a stopper (126) configured for blocking the liquid crystal panel from being pulled up. The liquid crystal display further includes a light guide plate (17) having a light incident surface (172). Light beams emitted from a plurality of point illuminators (18) enter the light incident surface (172) of the light guide plate 17, and the desired optical performance of liquid crystal display is stably maintained.

### FIELD OF THE INVENTION

The present invention relates to liquid crystal displays (LCDs), and more particularly to a liquid crystal display with a frame stopper blocking a liquid crystal panel.

### GENERAL BACKGROUND

Liquid crystal displays are commonly used as display devices for compact electronic apparatuses, because they not only provide good quality images but are also very thin.

Referring to FIG. 6, a typical liquid crystal display 6 includes a liquid crystal panel assembly 60, a first brightness enhancement film (BEF) 61, a second BEF 62, a diffusing film 63, and a light guide plate (LGP) 64, arranged in that order from top to bottom. The liquid crystal panel assembly 60 includes a liquid crystal panel 65, a driving integrated circuit (IC) 602, and a first flexible printed circuit (FPC) 604. The liquid crystal panel 65 defines a display region 652, and a non-display region 654 adjacent one end of the display region 652. The driving IC 602 is bonded at the non-display region 654 of the liquid crystal panel 65, and is electrically connected with the first FPC 604. The liquid crystal display 6 further includes four light emitting diodes 66, a second FPC 67, and a frame 68. The light emitting diodes 66 are disposed adjacent to a light incident surface 642 of the light guide plate 64, and are electrically connected with the second FPC 67. The frame 68 includes a supporting board 682, which defines a space (not labeled) for accommodating the first BEF 61, the second BEF 62, the diffusing film 63, and the light guide plate 64. The liquid crystal panel 65 is also received in the frame 68 such that it is supported on the supporting board 682.

When the liquid crystal display 6 is assembled, the liquid crystal panel 65, the first BEF 61, the second BEF 62, the diffusing film 63, the light guide plate 64, the light emitting diodes 66, and the second FPC 67 are received in the frame 68. A bottom portion (not shown) of the non-display region 654 of the liquid crystal panel 65 is adhered with a top portion of the second FPC 67 by double-sided adhesive masking tape (not shown). The first FPC 604 is then bent down and under the frame 68, which process may produce some stress in the first FPC 604. If the stress is significant, the first FPC 604 is liable to pull up the non-display region 654 of the liquid crystal panel 65. Because the non-display region 654 is adhered with the second FPC 67 having the light emitting diodes 66 connected thereto, the light emitting diodes 66 are pulled out of position. This problem is particularly prone to occur in a small-sized liquid crystal display having a lightweight liquid crystal panel. When displacement of the light emitting diodes 66 occurs, light beams emitted from the light emitting diodes 66 do not properly enter the light incident surface 642 of the light guide plate 64. That is, so-called light leakage is liable to occur. Thus, the optical performance of the liquid crystal display 6 may be impaired.

What is needed, therefore, is a liquid crystal display that can overcome the above-described deficiencies.

### SUMMARY

In one preferred embodiment, a liquid crystal display includes a liquid crystal panel and a frame receiving the liquid crystal panel. The frame includes a stopper configured for blocking the liquid crystal panel from being pulled up.

Other aspects, advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the described embodiments. In the drawings, like reference numerals designate corresponding parts throughout various views, and all the views are schematic.

FIG. 1 is an exploded, isometric view of a liquid crystal display according to a first embodiment of the present invention.

FIG. 2 is an assembled view of the liquid crystal display of FIG. 1.

FIG. 3 is an enlarged view of a circled portion III of FIG. 2.

FIG. 4 is an exploded, isometric view of a liquid crystal display according to a second embodiment of the present invention.

FIG. 5 is an enlarged view of a circled portion V of FIG. 4.

FIG. 6 is an exploded, isometric view of a conventional liquid crystal display.

### DETAILED DESCRIPTION OF PREFERRED EMBODIMENTS

Reference will now be made to the drawings to describe the preferred embodiments in detail.

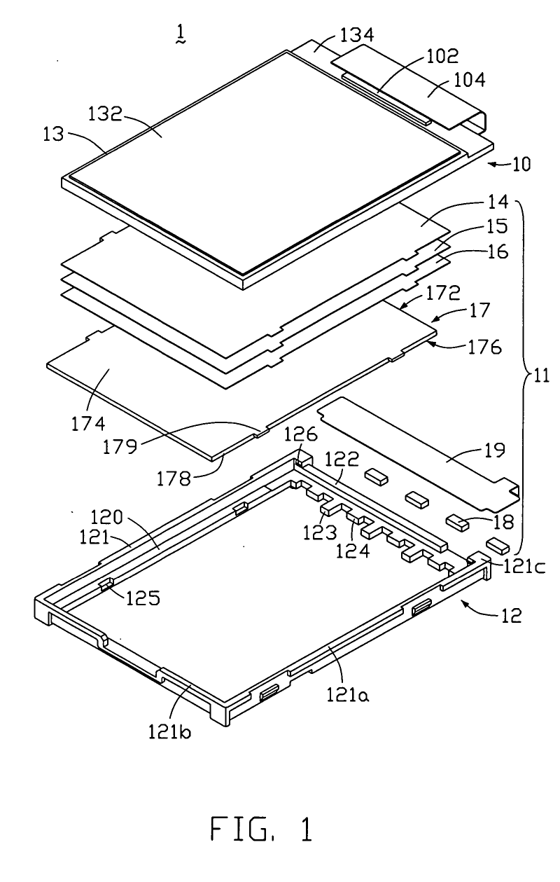

Referring to FIG. 1, a liquid crystal display 1 according to a first embodiment of the present invention is shown. The liquid crystal display 1 includes a liquid crystal panel assembly 10, a backlight module assembly 1, and a frame 12.

The liquid crystal panel assembly 10 includes a liquid crystal panel 13, a driving IC 102, and a first FPC 104. The liquid crystal panel 13 defines a display region 132, and a non-display region 134 adjacent an end of the display region 132. In the illustrated embodiment, an area occupied by the display region 132 is much larger than that occupied by the non-display region 134. The driving IC 102 is bonded at the non-display region 134 of the liquid crystal panel 13, and is electrically connected with the first FPC 104.

The backlight module assembly 11 includes a first BEF 14, a second BEF 15, a diffusing film 16, and a light guide plate 17, arranged in that order from top to bottom. The backlight module assembly 11 further includes a plurality of point illuminators 18 disposed adjacent to a light incident surface 172 of the light guide plate 17, and a second FPC 19 electrically connected with the point illuminators 18. In the illustrated embodiment, the point illuminators 18 are four light emitting diodes cooperatively serving as a light source for the backlight module 11.

The light guide plate 17 further includes a light emitting surface 174 perpendicularly connecting with the light incident surface 172, a bottom surface 176 opposite to the light emitting surface 174, and two opposite side surfaces 178 perpendicularly connecting with the light incident surface 172. That is, the light incident surface 172 and the side surfaces 178 are between the light emitting surface 174 and the bottom surface 176. The diffusing film 16 is disposed adjacent to the light emitting surface 174 of the light guide plate 17. A pair of ears 179 outwardly extend from each side surface 178. The ears 179 are adjacent respective end portions (not labeled) of each of the side surfaces 178. The light guide plate 17 can be made from polycarbonate (PC) or polymethyl methacrylate (PMMA), and can be manufactured by an injection molding method.

The frame 12 includes a supporting board 120, two symmetrically opposite generally U-shaped side walls 121, and a stopping bar 122. The supporting board 120 is generally frame-shaped, and integrally adjoins inner surfaces (not labeled) of the side walls 121. Thus the frame 12 defines a generally rectangular space (not labeled) for accommodating the liquid crystal panel assembly 10 and the backlight module assembly 11. The stopping bar 122 integrally extends up from one short side of the supporting board 120. Three first protrusions 123 and four second protrusions 124 are formed at an inner surface (not labeled) of the supporting board 120 adjacent the stopping bar 122. The first protrusions 123 and the second protrusions 124 extend into the space, and are parallel to each other and alternately arranged. The second protrusions 124 are shorter than the first protrusions 123, whereby four recesses (not labeled) are defined at the second protrusions 124 respectively. The point illuminators 18 can be respectively disposed in the recesses. In particular, the point illuminators 18 can be arranged to abut the second protrusions 124 respectively. The frame 12 further defines four notches (only two visible) 125 positioned at two opposite inner sides (not labeled) of the supporting board 120 respectively. Each notch 125 is located corresponding to one respective ear 179 of the light guide plate 17. That is, the ears 179 can be received in the notches 125 respectively. The frame 12 is preferably made from polycarbonate, plastic, or other suitable material.

Each side wall 121 has a generally asymmetrical U-shape, and includes a first arm 121a, a second arm 121b, and a third arm 121c. The first arm 121a extends along a corresponding long side of the frame 12. The second arm 121b and the third arm 121c respectively extend along two opposite short sides of the frame 12. The second arm 121b is longer than the third arm 121c. The second arms 121b of the opposite side walls 121 are aligned with each other, and the third arms 121c of the opposite side walls 121 are aligned with each other. The stopping bar 122 integrally adjoins only one of the third arms 121c. That is, an exit (not labeled) is defined between a distal end of the stopping bar 122 and the other third arm 121c.

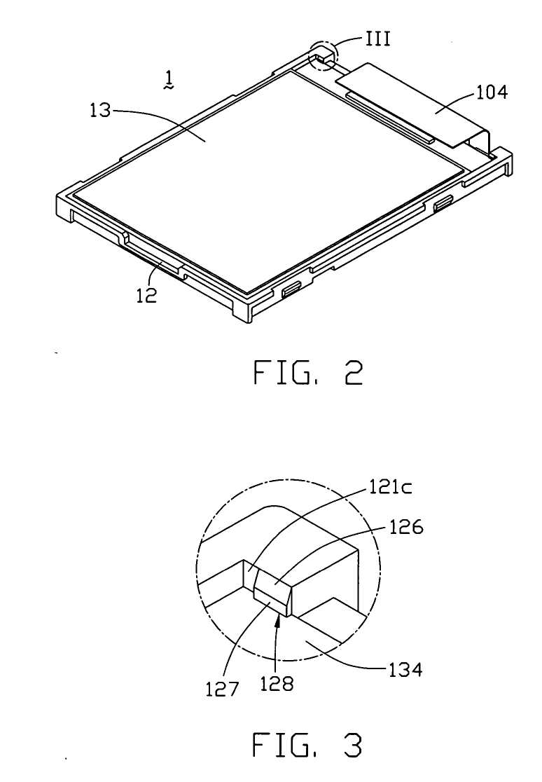

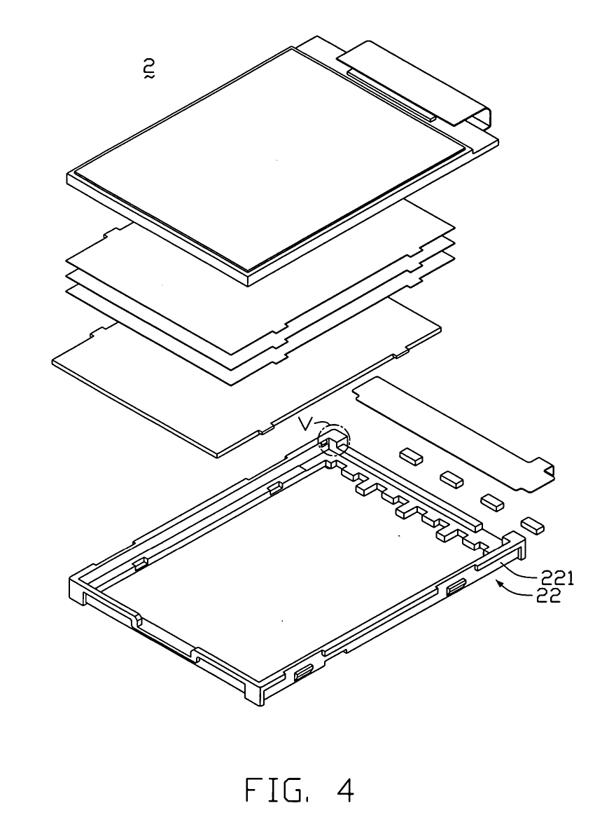

Also referring to FIG. 2 and FIG. 3, a pair of elastic stoppers 126 are formed at inner surfaces (not labeled) of the third arms 121c. Each stopper 126 has a generally trapezoidal profile. In the illustrated embodiment, the stopper 126 is a right-angled trapezoidal block. An outmost extremity 127 of the stopper 126 is parallel to the inner surface of the third arm 121c. The stopper 126 can be manufactured as an integral part of the frame 12 by an injection molding method. That is, the frame 12 including the stopper 126 can be made from polycarbonate, plastic or other suitable material.

When the liquid crystal display 1 is assembled, the liquid crystal panel 13, the first BEF 14, the second BEF 15, the diffusing film 16, and the light guide plate 17 are received in the frame 12 in that order. The ears 179 of the light guide plate 17 are received in the notches 125 of the supporting board 120 respectively. The point illuminators 18 are respectively received in the recesses, and are electrically connected with the second FPC 19. A bottom portion (not shown) of the non-display region 134 of the liquid crystal panel 13 is adhered with a top portion of the second FPC 19 by double-sided adhesive masking tape (not shown). The first FPC 104 is bent down and under the frame 12. A bottom surface 128 of each stopper 126 perpendicularly connecting the corresponding third arm 121c blocks a top edge portion (not labeled) of the non-display portion 134 of the liquid crystal panel 13. Typically, said top edge portion abuts the bottom surface 128 under elastic urging provided by the bent first FPC 104. Thus, the stoppers 126 of the frame 12 can prevent the liquid crystal panel 13 from being pulled up out of position due to stress in the bent first FPC 104. Accordingly, the second FPC 19 having the point illuminators 18 connected thereto is prevented from being pulled out of position. Light beams emitted from the point illuminators 18 properly enter the light incident surface 172 of the light guide plate 17, and the desired optical performance of liquid crystal display 1 is stably maintained.

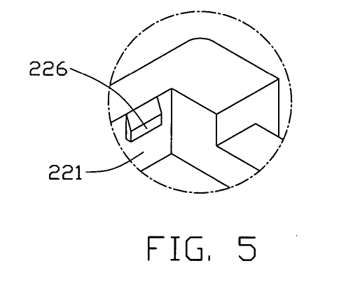

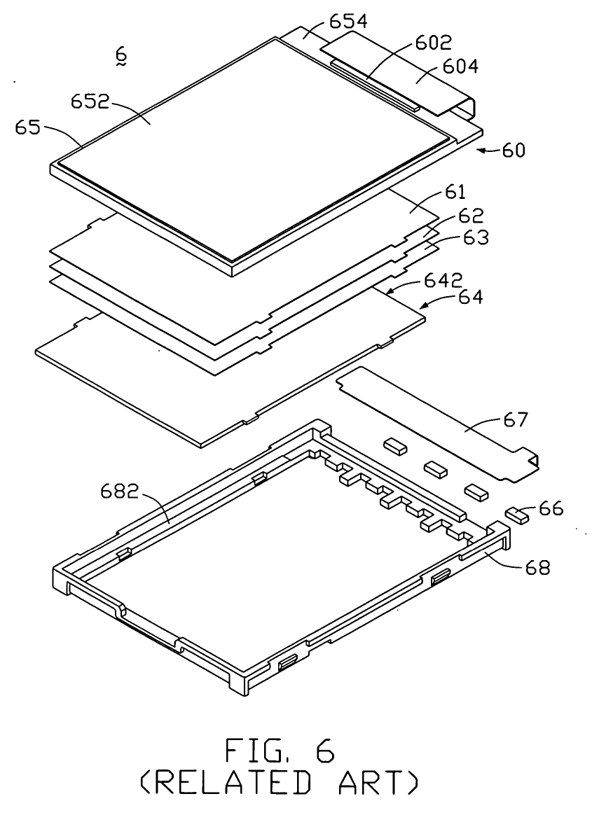

Referring to FIG. 4 and FIG. 5, a liquid crystal display 2 according to a second embodiment of the present invention is similar to the liquid crystal display 1. However, the liquid crystal display 2 includes a frame 22 having two symmetrically opposite generally U-shaped side wall 221. Each side wall 221 includes a first arm (not labeled) extending along a corresponding one of two opposite long sides (not labeled) of the frame 22. A stopper 226 integrally extends from an inner surface (not labeled) of an end portion of each side wall 221. The stopper 226 has a generally trapezoidal profile. In the illustrated embodiment, the stopper 226 is a right-angled trapezoidal block. The liquid crystal display 2 with the stoppers 226 can achieve advantages similar to those of the liquid crystal display 1 described above.

Further or alternative embodiments may include the following alternative configurations of the stoppers 126, 226. For example, each stopper 126, 226 can have an isosceles trapezoidal configuration, a right-angled triangular configuration, a pentagonal configuration, a hexagonal configuration, or any other suitable configuration. Preferably, the selected configuration has a bottom flat portion for blocking the top edge portion of the non-display portion 134 of the liquid crystal panel 13, whereby the liquid crystal panel 13 is prevented from being pulled up.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display comprising:
a liquid crystal panel; and
a frame receiving the liquid crystal panel, the frame comprising a stopper configured for blocking the liquid crystal panel from being pulled up.

2. The liquid crystal display in claim 1, wherein the liquid crystal panel defines a display region, and a non-display region adjacent the display region.

3. The liquid crystal display in claim 2, wherein the non-display region is at an end of the liquid crystal panel.

4. The liquid crystal display in claim 2, further comprising a driving integrated circuit board attached at the non-display region of the liquid crystal panel.

5. The liquid crystal display in claim 4, further comprising a first flexible printed circuit board electrically connected with the driving integrated circuit.

6. The liquid crystal display in claim 5, further comprising a plurality of point illuminators received in the frame and configured for cooperatively serving as a light source for the liquid crystal display.

7. The liquid crystal display in claim 6, further comprising a second flexible printed circuit board electrically connected with the point illuminators.

8. The liquid crystal display in claim 6, wherein the point illuminators are light emitting diodes.

9. The liquid crystal display in claim 7, wherein a bottom portion of the non-display region is attached to the second flexible printed circuit board.

10. The liquid crystal display in claim 9, wherein the first flexible printed circuit board bends away from the driving integrated circuit and down and under the frame.

11. The liquid crystal display in claim 10, wherein the stopper comprises a surface portion contacting a top edge portion of the non-display region.

12. The liquid crystal display in claim 11, wherein the top edge portion of the non-display region abuts the surface portion of the stopper under elastic urging by the first flexible printed circuit board.

13. The liquid crystal display in claim 1, wherein the stopper has a configuration selected from the group consisting of a trapezoidal profile, a right-angled trapezoidal configuration, an isosceles trapezoidal configuration, a right-angled triangular configuration, a pentagonal configuration, and a hexagonal configuration.

14. The liquid crystal display in claim 13, wherein the stopper is a right-angled trapezoidal block.

15. The liquid crystal display in claim 14, wherein the stopper comprises a surface portion perpendicularly extending from a main body of the frame, and the surface portion is configured for blocking the liquid crystal panel.

16. The liquid crystal display in claim 1, wherein the stopper is an integral part of the frame.

17. The liquid crystal display in claim 16, wherein the stopper is at a short side of the frame.

18. The liquid crystal display in claim 16, wherein the stopper is at a long side of the frame.

19. A liquid crystal display comprising:
a liquid crystal panel;
a flexible printed circuit board connected to the liquid crystal panel and bending away therefrom; and
a frame receiving the liquid crystal panel, the frame comprising a stopper blocking a top surface of the liquid crystal panel.

20. The liquid crystal display in claim 19, wherein the liquid crystal panel comprises a non-display region, and the non-display region abuts the stopper under elastic urging by the flexible printed circuit board.
